(19) United States
(12) Patent Application Publication
(10) Pub. No.: US 2025/0034942 A1
(43) Pub. Date: Jan. 30, 2025

(54) STABILIZATION SYSTEM, SYSTEM FOR STABILIZING A STRUCTURE, LADDER LEVELING SYSTEM, PROCESS, AND METHOD OF USE

(71) Applicants: Colton Yingling, Topeka, KS (US); Marty Randol, Topeka, KS (US)

(72) Inventors: Colton Yingling, Topeka, KS (US); Marty Randol, Topeka, KS (US)

(21) Appl. No.: 18/780,563

(22) Filed: Jul. 23, 2024

Related U.S. Application Data
(60) Provisional application No. 63/529,181, filed on Jul. 27, 2023.

(51) Int. Cl. E06C 7/44; E06C 7/42

(52) U.S. Cl. CPC E06C 7/44; E06C 7/423

(57) ABSTRACT

A stabilization system, a system for stabilizing a structure or device, a ladder leveling and stabilization system, processes, and methods of use are presented. The present disclosure relates to a stabilization and adjustment system which levels and stabilizes a ladder, scaffolding, or other device so that the device can be engaged safely.

### CROSS-REFERENCE TO RELATED APPLICATIONS

The present application claims priority to the U.S. Provisional Patent Application No. 63/529,181 which was filed on Jul. 27, 2023, which is hereby incorporated by reference herein in its entirety, including any figures, tables, or drawings.

### FIELD OF THE INVENTION

This disclosure relates to a stabilization system, a system for stabilizing a structure or device, a ladder leveling and stabilization system, processes, and methods of use. More specifically, and without limitation, the present disclosure relates to a stabilization and adjustment system which levels and stabilizes a ladder, scaffolding, or other device so that the device can be engaged safely.

### BACKGROUND OF THE INVENTION

Ladders are well known in the art. Ladders have been around for hundreds of years, if not longer, but little to few improvements have been made in ladder technology and usage over the centuries. A ladder is a vertical set of steps and/or rungs which are used for climbing and/or gaining access to objects and the like at various heights. Ladders are typically leaned against a structure such as a building, a tree, a pole, or the like.

Ladders are very helpful tools in achieving goals related to reaching heights. Ladders, however, are known to be dangerous and often result in injuries of the user due to various instabilities. Some of the instabilities are angles of the ladder against a structure, disparity in distance of the feet of the ladder from the structure, softness of the ground surface, levelness of the ladder feet, ice, slippery surfaces and the like.

Scaffolding is well known in the art. Like ladders, scaffolding is old and has been around for centuries. Similarly, little improvement in the technology of scaffolding has been made over the years. Scaffolding, similarly, also helps a user reach and/or work at heights a user can not otherwise reach. Other devices exist such as scaffolding and/or tools that one would utilize and/or need to stabilize, even if that user does not wish to climb on. Scaffolding, similarly, provides dangers in use and access related to the surface on which scaffolding sits or is used upon. These dangers can result in injury and often do.

Ladders and/or scaffolding and similar structures are used in construction, by homeowners, and the like around the globe during projects, remodeling, construction, home maintenance and more. Furthermore, often more than one person is needed for accessing a ladder taking up valuable time and resources.

Thus, there is a long-felt need in the art for a stabilization system, a system for stabilizing a structure or device, a ladder leveling and stabilization system, processes, and methods of use which improves upon the state of the art and solves leveling and stabilization issues so as to make ladders, scaffolding, and similar structures safer and more reliable in use. Said another way, a safer, easier system which doesn't require additional personnel to operate is disclosed herein.

The disclosure herein provides these advantages and others as will become clear from the specification and claims provided.

### SUMMARY OF THE INVENTION

A stabilization system, a system for stabilizing a structure or device, a ladder leveling and stabilization system, processes, and methods of use are presented.

More specifically, and without limitation, the present disclosure relates to a stabilization system, a system for stabilizing a structure or device, a ladder leveling and stabilization system, processes, and methods of use. More specifically, and without limitation, the present disclosure relates to a stabilization and adjustment system which levels and stabilizes a ladder, scaffolding, or other device so that the device can be engaged safely.

Thus, it is a primary object of the disclosure to provide a stabilization system, a system for stabilizing a structure or device, a ladder leveling and stabilization system, processes, and methods of use that improves upon the state of the art.

Another object of the disclosure is to provide a stabilization system, a system for stabilizing a structure or device, a ladder leveling and stabilization system, processes, and methods of use that is extendable, adding length to a device.

Yet another object of the disclosure is to provide a stabilization system, a system for stabilizing a structure or device, a ladder leveling and stabilization system, processes, and methods of use that levels a ladder or other system by providing different levels of height adjustments and combinations for each foot.

Another object of the disclosure is to provide a stabilization system, a system for stabilizing a structure or device, a ladder leveling and stabilization system, processes, and methods of use that operate independently of one another so that each foot can provide different heights.

Yet another object of the disclosure is to provide a stabilization system, a system for stabilizing a structure or device, a ladder leveling and stabilization system, processes, and methods of use that swivels in a full rotation and/or 360 degrees, such that any orientation can be achieved.

Another object of the disclosure is to provide a stabilization system, a system for stabilizing a structure or device, a ladder leveling and stabilization system, processes, and methods of use that include spikes for sinking into earth, ice, and/or other materials.

Yet another object of the disclosure is to provide a stabilization system, a system for stabilizing a structure or device, a ladder leveling and stabilization system, processes, and methods of use that can be adjusted almost instantaneously with relatively little effort and time.

Another object of the disclosure is to provide a stabilization system, a system for stabilizing a structure or device, a ladder leveling and stabilization system, processes, and methods of use that utilize a plurality of cleats to grip a surface.

Yet another object of the disclosure is to provide a stabilization system, a system for stabilizing a structure or device, a ladder leveling and stabilization system, processes, and methods of use that includes a grip or non-skid surface for preventing slippage on a surface.

Another object of the disclosure is to provide a stabilization system, a system for stabilizing a structure or device, a ladder leveling and stabilization system, processes, and methods of use that do not require tools for installation.

Yet another object of the disclosure is to provide a stabilization system, a system for stabilizing a structure or device, a ladder leveling and stabilization system, processes, and methods of use that does not require tools for adjustments and/or use.

Another object of the disclosure is to provide a stabilization system, a system for stabilizing a structure or device, a ladder leveling and stabilization system, processes, and methods of use that can be easily removed from one device and attached to another device.

Yet another object of the disclosure is to provide a stabilization system, a system for stabilizing a structure or device, a ladder leveling and stabilization system, processes, and methods of use that operates safely in wet conditions.

Another object of the disclosure is to provide a stabilization system, a system for stabilizing a structure or device, a ladder leveling and stabilization system, processes, and methods of use that operate safely in ice conditions.

Yet another object of the disclosure is to provide a stabilization system, a system for stabilizing a structure or device, a ladder leveling and stabilization system, processes, and methods of use that operates in a variety of applications.

Another object of the disclosure is to provide a stabilization system, a system for stabilizing a structure or device, a ladder leveling and stabilization system, processes, and methods of use that hooks on to ledges such as locking onto the edge of a stair or shelf; preventing slippage.

Yet another object of the disclosure is to provide a stabilization system, a system for stabilizing a structure or device, a ladder leveling and stabilization system, processes, and methods of use that work on uneven surfaces.

Another object of the disclosure is to provide a stabilization system, a system for stabilizing a structure or device, a ladder leveling and stabilization system, processes, and methods of use that hook onto edges, ledges; such as sidewalks, pavers, steps, hardscapes, roots and other features.

Yet another object of the disclosure is to provide a stabilization system, a system for stabilizing a structure or device, a ladder leveling and stabilization system, processes, and methods of use that can hook onto decks in between boards, without damaging the surface; similar to expansion joints of concrete features.

Another object of the disclosure is to provide a stabilization system, a system for stabilizing a structure or device, a ladder leveling and stabilization system, processes, and methods of use that provides for attachment features to lock and/or secure in place for added safety.

Yet another object of the disclosure is to provide a stabilization system, a system for stabilizing a structure or device, a ladder leveling and stabilization system, processes, and methods of use that includes a non-slip grip rubber foot.

Another object of the disclosure is to provide a stabilization system, a system for stabilizing a structure or device, a ladder leveling and stabilization system, processes, and methods of use that is a self-contained unit.

Yet another object of the disclosure is to provide a stabilization system, a system for stabilizing a structure or device, a ladder leveling and stabilization system, processes, and methods of use that includes three rotating spikes.

Another object of the disclosure is to provide a stabilization system, a system for stabilizing a structure or device, a ladder leveling and stabilization system, processes, and methods of use that utilizes a spring loaded shaft for easy adjusting.

Yet another object of the disclosure is to provide a stabilization system, a system for stabilizing a structure or device, a ladder leveling and stabilization system, processes, and methods of use that includes a plurality of handles for adjusting the levels and/or other features of the system.

Another object of the disclosure is to provide a stabilization system, a system for stabilizing a structure or device, a ladder leveling and stabilization system, processes, and methods of use that are easy to use.

Yet another object of the disclosure is to provide a stabilization system, a system for stabilizing a structure or device, a ladder leveling and stabilization system, processes, and methods of use that are safe to use.

Yet another object of the disclosure is to provide a stabilization system, a system for stabilizing a structure or device, a ladder leveling and stabilization system, processes, and methods of use that are quick and efficient.

Yet another object of the disclosure is to provide a stabilization system, a system for stabilizing a structure or device, a ladder leveling and stabilization system, processes, and methods of use that are robust.

Another object of the disclosure is to provide a stabilization system, a system for stabilizing a structure or device, a ladder leveling and stabilization system, processes, and methods of use that saves time for a user.

Yet another object of the disclosure is to provide a stabilization system, a system for stabilizing a structure or device, a ladder leveling and stabilization system, processes, and methods of use that saves energy.

Another object of the disclosure is to provide a stabilization system, a system for stabilizing a structure or device, a ladder leveling and stabilization system, processes, and methods of use that are high quality.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a top, perspective view of one embodiment of a stabilization system; the view showing a shaft, the view showing a sliding clamp feature, the view showing a foot with adjustable spike features, and a securement feature.

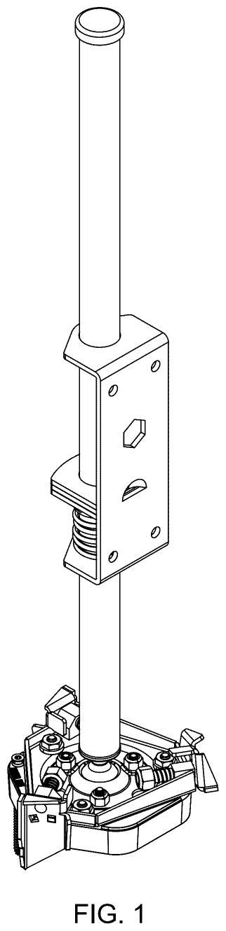

FIG. 2 is a top, perspective view of one embodiment of a stabilization system; the view showing a shaft, the view showing a sliding clamp feature, the view showing a foot with adjustable spike features, and a securement feature.

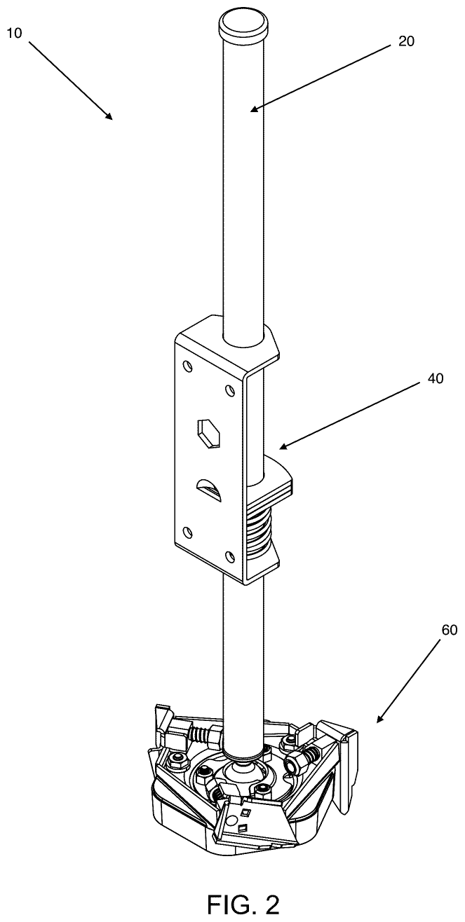

FIG. 3 is a top, perspective view of one embodiment of a stabilization system; the view showing a shaft, the view showing a sliding clamp feature, the view showing a foot with adjustable spike features, and a securement feature.

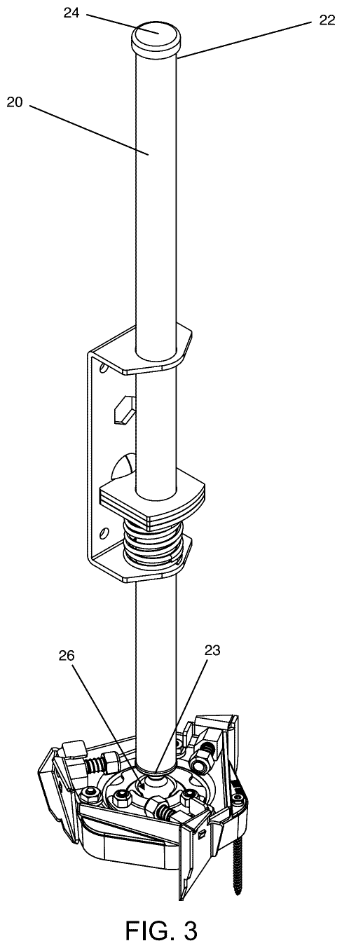

FIG. 4 is a top, perspective view of one embodiment of a stabilization system; the view showing a shaft, the view showing a sliding clamp feature, the view showing a foot with adjustable spike features, and a securement feature.

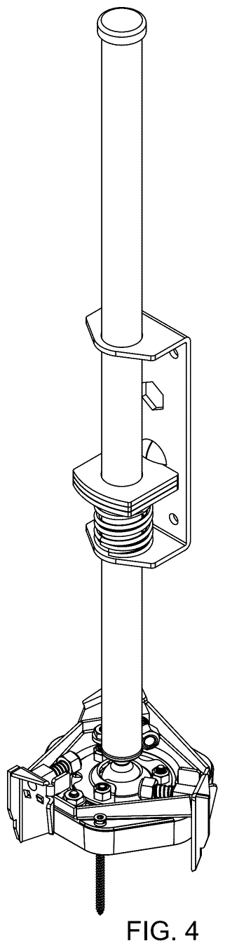

FIG. 5 is a side view of one embodiment of a stabilization system; the view showing a shaft, the view showing a sliding clamp feature, the view showing a foot with adjustable spike features, and a securement feature.

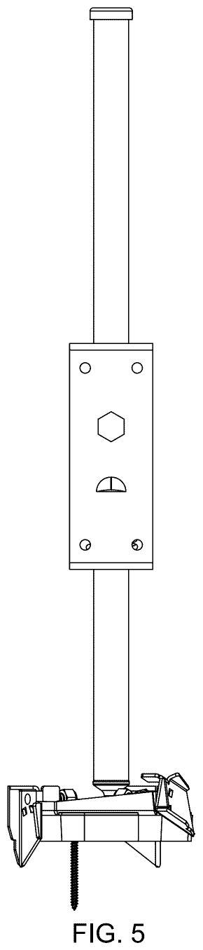

FIG. 6 is a side view of one embodiment of a stabilization system; the view showing a shaft, the view showing a sliding clamp feature, the view showing a foot with adjustable spike features, and a securement feature.

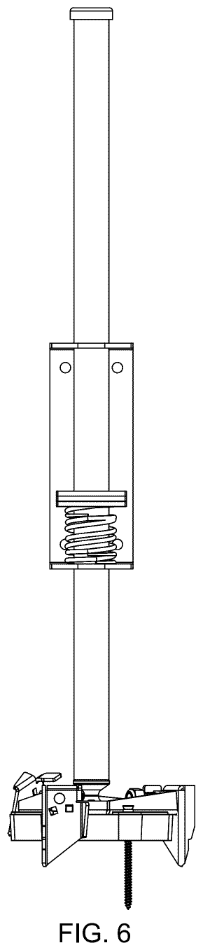

FIG. 7 is a rear view of one embodiment of a stabilization system; the view showing a shaft, the view showing a sliding clamp feature, the view showing a foot with adjustable spike features, and a securement feature.

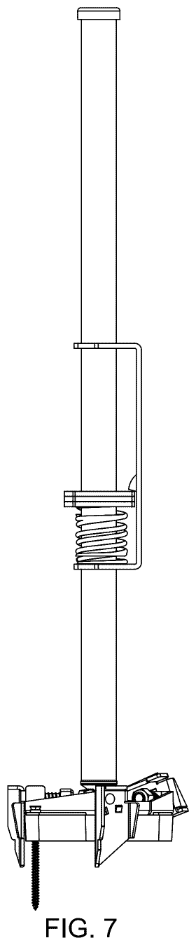

FIG. 8 is a front view of one embodiment of a stabilization system; the view showing a shaft, the view showing a sliding clamp feature, the view showing a foot with adjustable spike features, and a securement feature.

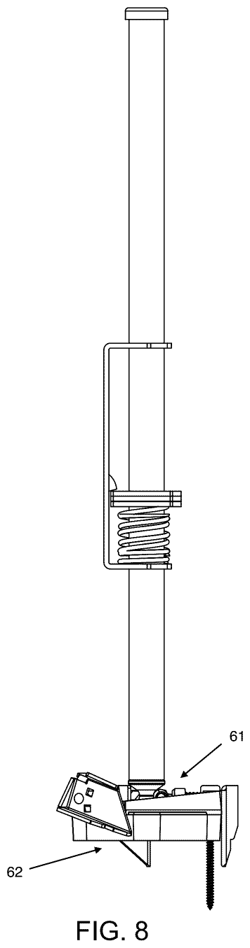

FIG. 9 is a top view of one embodiment of a stabilization system; the view showing the cap of the shaft, the view showing the top of the main body of the sliding clamp feature, the view showing a foot with adjustable spike features, and a securement feature.

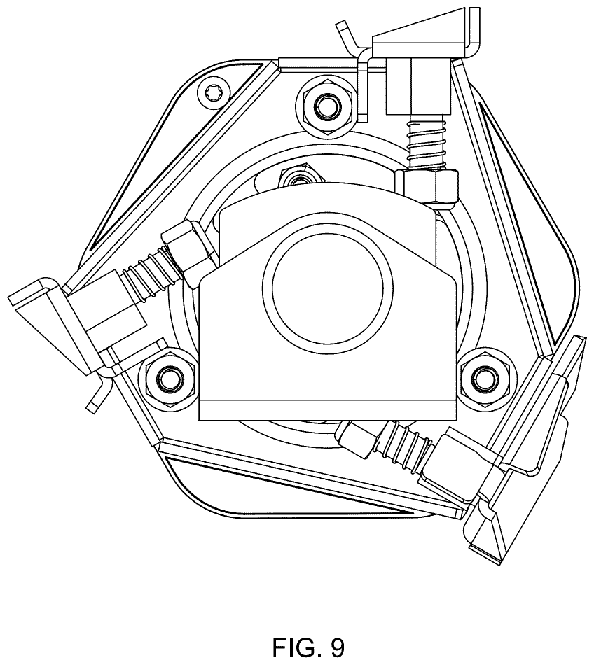

FIG. 10 is a bottom view of one embodiment of a stabilization system; the view showing a foot with adjustable spike features, and a securement feature.

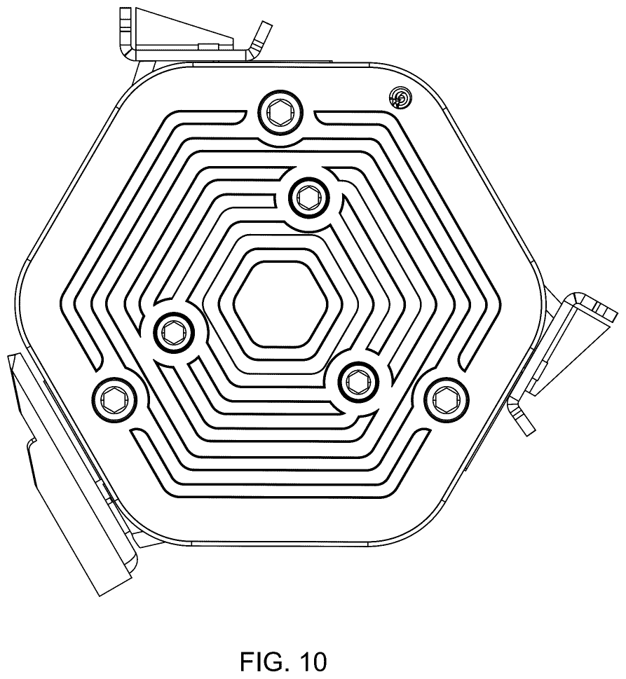

FIG. 11 is a bottom, perspective view of one embodiment of a stabilization system; the view showing a shaft, the view showing a sliding clamp feature, the view showing a foot with adjustable spike features, and a securement feature.

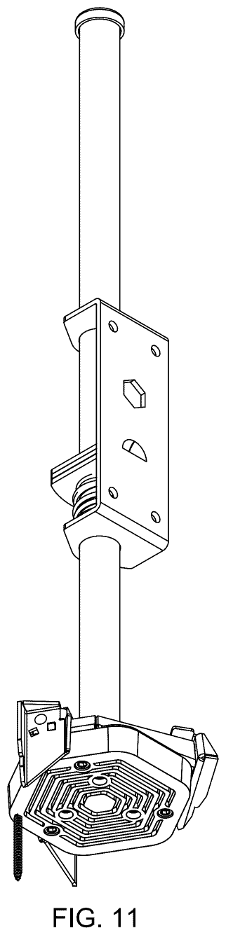

FIG. 12 is a bottom, perspective view of one embodiment of a stabilization system; the view showing a shaft, the view showing a sliding clamp feature, the view showing a foot with adjustable spike features, and a securement feature.

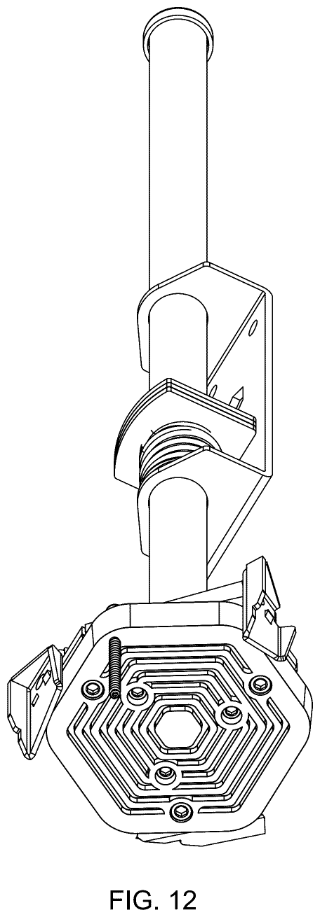

FIG. 13 is a top, perspective view of one embodiment of a stabilization system; the view showing a shaft, the view showing a sliding clamp feature, the view showing a foot with adjustable spike features, and a securement feature.

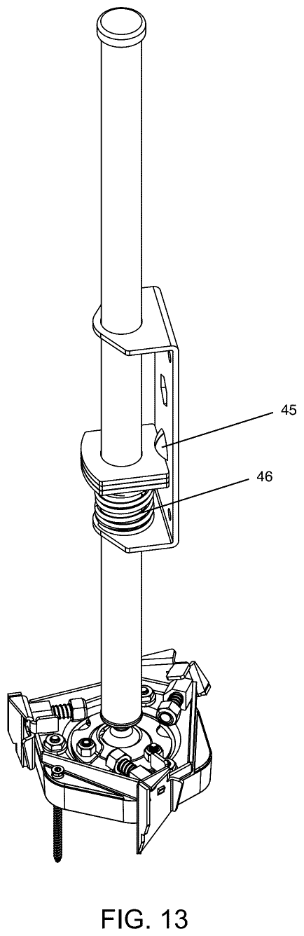

FIG. 14 is a bottom, perspective view of one embodiment of a stabilization system; the view showing a shaft, the view showing a sliding clamp feature, the view showing a foot with adjustable spike features, and a securement feature.

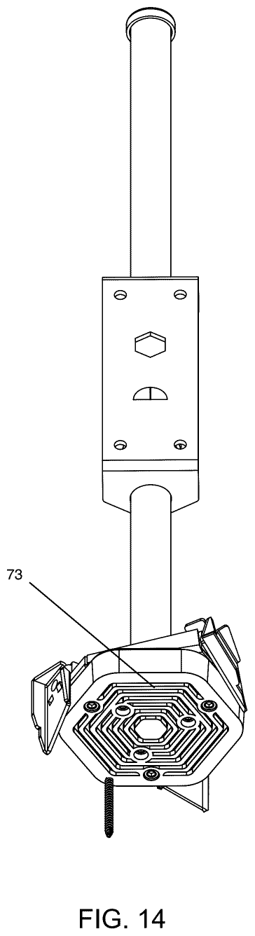

FIG. 15 is an exploded top, perspective view of one embodiment of a stabilization system; the view showing a shaft, the view showing a sliding clamp feature, the view showing a foot with adjustable spike features, and a securement feature.

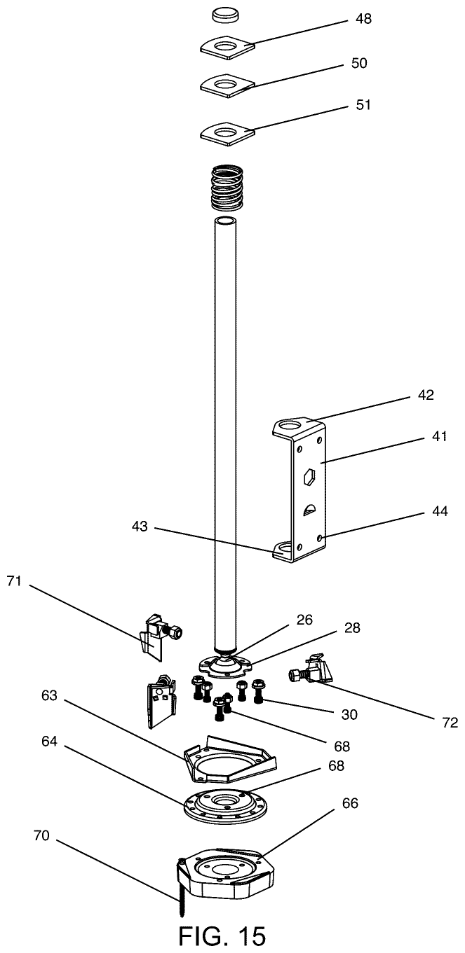

FIG. 16 is an exploded bottom, perspective view of one embodiment of a stabilization system; the view showing a shaft, the view showing a sliding clamp feature, the view showing a foot with adjustable spike features, and a securement feature.

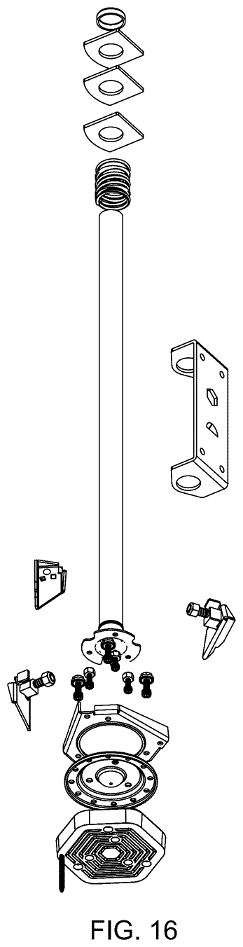

FIG. 17 is an exploded bottom, perspective view of one embodiment of a stabilization system; the view showing a shaft, the view showing a sliding clamp feature, the view showing a foot with adjustable spike features, and a securement feature.

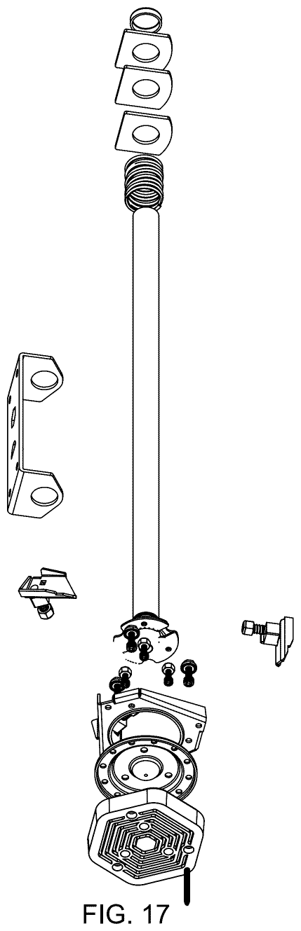

FIG. 18 is a top, perspective view of one embodiment of a stabilization system; the view showing the foot of the system; the view showing the ball and socket attachment feature without the shaft.

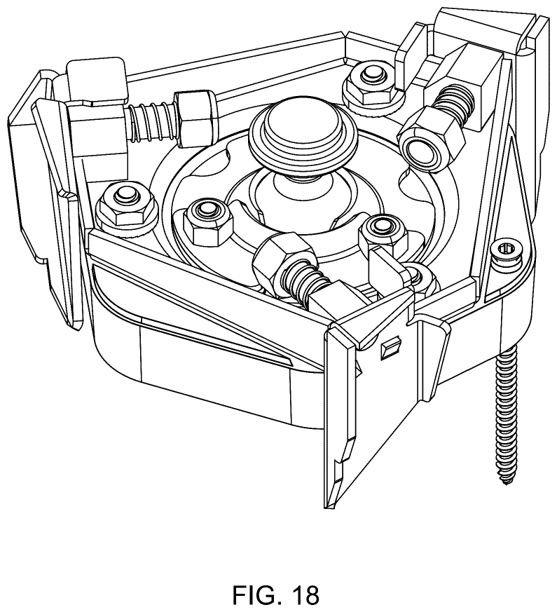

FIG. 19 is a bottom, perspective view of one embodiment of a stabilization system; the view showing the foot; the view showing and example of one spike in an engaged position and another spike in a disengaged position; the view showing the securement feature in an engaged position.

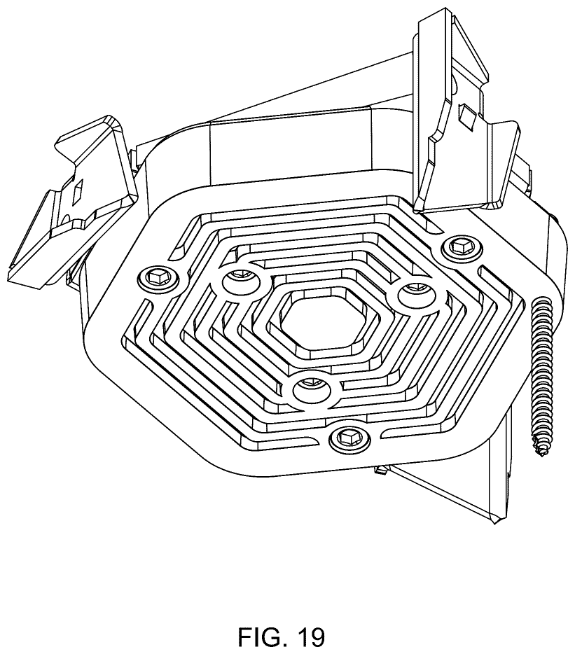

FIG. 20 is a top, perspective view of one embodiment of a stabilization system; the view showing the foot of the system; the view showing the ball and socket attachment feature without the shaft.

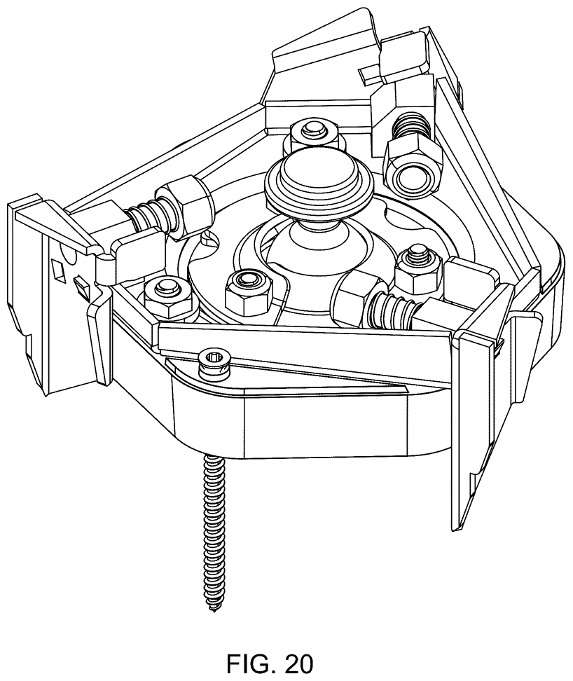

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

### System

With reference to the figures, a stabilization system, a system for stabilizing a structure or device, a ladder leveling and stabilization system, processes, and methods of use 10 are presented. a stabilization system, a system for stabilizing a structure or device, a ladder leveling and stabilization system, processes, and methods of use 10 (hereafter referred to as “leveling system”, “stabilization system”, “ladder leveler”, “grip system”, or simply “system”) is formed of any suitable size, shape and design.

In the arrangement shown, as one example, the main structure of system 10 includes a rod, a plurality of attachment features, a spring loaded slider, a gyro feature, a pivot connection, a main body of the foot, a perimeter edge, a plurality of cleats, a plurality of engagement mechanisms, a securement mechanism, and a grip, among other components, features, and functionality.

### User (or Plurality Thereof)

In the arrangement shown, as one example, system 10 may also include a user. User may be any user interacting with or utilizing the system 10. This may include viewing, controlling, analyzing, manipulating, and/or interacting with system 10. User is not limited to a single user but may be a plurality of users.

### Shaft

In the arrangement shown, as one example, system 10 includes a shaft 20 or rod 20, also referred to as an “extension feature” or “rod”. Shaft 20 is formed of any suitable size, shape, and design, and is configured to act as a main structure of system 10. Shaft 20 is configured to extend the ladder for adjusting on unlevel and/or uneven ground. The rod extends a length from a first end 22 (or top end having a cap 24; to be further described herein) to a second end 23 having a ball and socket joint 26.

The ball and socket joint 26 also includes an attachment surface 28 which extends outwardly to provide for attachment to the foot. Furthermore, the shaft includes a plurality of attachment feature 30 for attachment to the foot. In one example, the attachment features 30 are nut and bolt arrangements. In an alternative embodiment, this feature may also be a rivet connection, a welded connection, and other similar attachment connections.

In the arrangement shown, as one example, the shaft may also have a hollow interior and an exterior surface.

### Slider Clamp

In the arrangement shown, as one example, system 10 includes a slider clamp 40, also referred to as “a spring loaded adjustment feature” or “clamp” with a handle. In this way, the rod can be quickly extended and/or retracted and quickly locked into place for adjusting on uneven and/or unlevel ground. The slider clamp 40 includes a main body 41 having a top hold 42 and a bottom hold 43, a plurality of attachment features 44—for securing the slider clamp to a ladder)—a plate stop 45—for providing a maximum engagement point (wherein the maximum engagement point is when the spring is activated causing a frictional force between the plates and the shaft which locks the slider clamp into a location along the length of the shaft. Furthermore, the slider clamp includes a spring 46 which engages the bottom hold 43 and the third plate 51—which causes the plates to become off perpendicular to the shaft creating the frictional stopping such that the slider clamp no longer moves freely along the shaft. Furthermore, the slider clamp may also include a first plate 48, and a second plate 50.

In the arrangement shown, as one example, the rod secures with movability at a pivot point such that the angle of the ladder and/or rod can be easily adjusted to accommodate uneven and/or changes in the surface. Said another way, the spring loaded system can be disengaged by pinching, squeezing, or handling such that the rod can slide within the spring loaded adjustment feature.

### Foot

In the arrangement shown, as one example, system 10 includes a foot (also referred to as “grip”, “engagement system”, or simply “feet”). Foot 60 is formed of any suitable size, shape, and design, and are configured to engage a ground surface. Feet are formed as the primary mounting point for a plurality of features. In the arrangement shown, a single foot is displayed. However, many applications will utilize two feet for the two parts of a ladder which engage the ground. Some ladders may have three feet, four feet, or more which engage the ground and may utilize additional feet. Similarly, a single foot may be utilized in particular applications for ease such as uneven terrain (leveling a ladder) and the like.

In the arrangement shown, as one example, the foot 60 extends from a top 61 to a bottom 62, including a first attachment plate 63, a second attachment plate 64, and a main body 66 or grip 66.

Grip: In the arrangement shown, as one example, foot includes a grip feature which engages a ground surface. The grip surface is formed of a non-slip surface and also includes a pattern which prevents slippage. The grip 66 or main body also holds the other features of the foot together and provides various attachment and shapes for attachment and the like. Foot 60 also includes a plurality of attachment features 68 for such a purpose. The foot also includes a grip surface 73—wherein the grip surface is shown as a rubber-like material but may be other materials. The rubber-like or rubber material shown for ease of explanation and as one embodiment. The foot also includes a plurality of securement features 70, and a plurality of spikes 71 having adjustable features for engagement and disengagement-wherein engaging is activating so the spikes dig into a surface and disengagement is twisting the spikes so that the spikes do not engage a surface.

Securement Feature: In the arrangement shown, as one example, foot includes a securement feature. Securement feature is formed of any suitable size, shape, or design and is configured to securely attach the foot to a surface if desired. In one arrangement, as is shown, the securement feature is a screw and an aperture through the foot. The screw can be engaged with a wood surface or ground surface. Similarly, the securement feature may be a stake, a spike, suction cup, combination thereof, or other securement feature.

Spikes: In the arrangement shown, as one example, foot includes a plurality of cleats. The plurality of cleats are formed of any suitable size, shape, and design and are configured to secure the grip in a location on a surface. The plurality of cleats are configured as spikes, or similar in one example as is shown. The plurality of feet can also be adjusted to varying distances from the pivot point and/or center of the foot such that the plurality of cleats are operably connected to the foot. In the arrangement shown, as one example, the plurality of cleats can also be rotated such that the plurality of cleats can be engaged and/or disengaged.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A stabilization system, comprising:
a shaft;
the shaft extending a length from a first end to a second end;
a slider clamp;
the slider clamp having a plurality of attachment features; wherein the plurality of attachment features provide for securing the system to a ladder leg;
the slider clamp having a plate stop;
the slider clamp having a spring;
the slider having a plurality of plates;
a foot;
the foot having a top and a bottom;
the foot having a main body;
the foot having a plurality of attachment features.

2. The system of claim 1, further comprising:
wherein the plurality of attachment features provide for securing the system to a ladder leg;
wherein the plurality of attachment features are apertures for nut and bolt configurations.

3. The system of claim 1, further comprising:
wherein the slider clamp slides freely along the length of the shaft when the plurality of plates are engaged; wherein engagement of the plurality of plates if pressing of the plurality of plates away from the plate stop and causing the spring to compress;
wherein disengagement of the plurality of plates is releasing of the plurality of plates so that the spring forces the plurality of plates into contact with the plate stop.

4. The system of claim 1, further comprising:
the shaft having a cap;
wherein the cap provides for removal and assembly of the main body in operable connection with the shaft.

5. The system of claim 1, further comprising:
wherein the ball and socket joint provides for gyrational positioning; wherein gyrational positioning allows for the foot to change from perpendicular to the shaft to varying angles in various directions.

6. The system of claim 1, further comprising:
the foot having a plurality of spikes; the plurality of spikes having a plurality of adjustment features;
wherein the plurality of spikes can each be engaged and disengaged; wherein engagement is rotating the plurality of spikes such that the plurality of spikes extend further downward than the grip surface of the foot; wherein disengagement is rotating the plurality of spikes such that the plurality of spikes do not extend further downward than the grip surface of the foot.

7. The system of claim 1, further comprising:
the foot having a plurality of securement features;
wherein the plurality of securement features can be engaged and disengaged; wherein engagement of the plurality of securement features is screwing into a surface and securing system to the surface such that the system will stay in place; wherein disengagement is unscrewing the plurality of securement features from the surface such that the system can move about freely.

8. The system of claim 1, further comprising:
the foot having a plurality of spikes; the plurality of spikes having a plurality of adjustment features.

9. The system of claim 1, further comprising:
the plurality of plates having a first plate;
the plurality of plates having a second plate;
the plurality of plates having a third plate.

10. The system of claim 1, further comprising:
the foot having a grip surface.

11. The system of claim 1, further comprising:
the shaft having a cap.

12. The system of claim 1, further comprising:
the shaft having a ball and socket joint; the ball and socket joint having a ball and a socket; the ball and socket joint having an attachment surface; the ball and socket joint having a plurality of attachment features.

13. The system of claim 1, further comprising:
the slider clamp having a main body; the main body having a top hold and a bottom hold.

14. The system of claim 1, further comprising:
wherein the plurality of attachment features are apertures for nut and bolt configurations.

15. The system of claim 1, further comprising:
the foot having a first attachment plate;
the foot having a second attachment plate.

16. The system of claim 1, further comprising:
the foot having an attachment plate.

17. A securement device:
a shaft;
the shaft extending a length from a first end to a second end;
the shaft having a cap;
the shaft having a ball and socket joint; the ball and socket joint having a ball and a socket; the ball and socket joint having an attachment surface; the ball and socket joint having a plurality of attachment features;
a slider clamp;
the slider clamp having a main body; the main body having a top hold and a bottom hold;
the slider clamp having a plurality of attachment features; wherein the plurality of attachment features provide for securing the system to a ladder leg; wherein the plurality of attachment features are apertures for nut and bolt configurations;
the slider clamp having a plate stop;
the slider clamp having a spring;
the slider having a plurality of plates;
the plurality of plates consist of a first plate;
the plurality of plates consist of a second plate;
the plurality of plates consist of a third plate;
a foot;
the foot having a top and a bottom;
the foot having a first attachment plate;
the foot having a second attachment plate;
the foot having a main body;
the foot having a plurality of attachment features;
the foot having a plurality of securement features;
the foot having a plurality of spikes; the plurality of spikes having a plurality of adjustment features.

18. The system of claim 17, further comprising:
wherein the slider clamp slides freely along the length of the shaft when the plurality of plates are engaged; wherein engagement of the plurality of plates if pressing of the plurality of plates away from the plate stop and causing the spring to compress;
wherein disengagement of the plurality of plates is releasing of the plurality of plates so that the spring forces the plurality of plates into contact with the plate stop;
wherein the cap provides a stop at the top of the shaft such that the main body can not slide further than the cap and become separated from the shaft;
wherein the cap provides for removal and assembly of the main body in operable connection with the shaft;
wherein the ball and socket joint provides for gyrational positioning; wherein gyrational positioning allows for the foot to change from perpendicular to the shaft to varying angles in various directions;
wherein the plurality of spikes can each be engaged and disengaged; wherein engagement is rotating the plurality of spikes such that the plurality of spikes extend further downward than the grip surface of the foot; wherein disengagement is rotating the plurality of spikes such that the plurality of spikes do not extend further downward than the grip surface of the foot;
wherein the plurality of securement features can be engaged and disengaged; wherein engagement of the plurality of securement features is screwing into a surface and securing system to the surface such that the system will stay in place; wherein disengagement is unscrewing the plurality of securement features from the surface such that the system can move about freely.

19. A method for stabilizing and leveling a ladder, the steps including:
providing at least one ladder leveling systems; the at least one ladder leveling system comprising:
a shaft;
the shaft extending a length from a first end to a second end;
the shaft having a cap;
the shaft having a ball and socket joint; the ball and socket joint having a ball and a socket; the ball and socket joint having an attachment surface; the ball and socket joint having a plurality of attachment features;
a slider clamp;
the slider clamp having a main body; the main body having a top hold and a bottom hold;
the slider clamp having a plurality of attachment features; wherein the plurality of attachment features provide for securing the system to a ladder leg;
wherein the plurality of attachment features are apertures for nut and bolt configurations;
the slider clamp having a plate stop;
the slider clamp having a spring;
the slider having a plurality of plates;
the plurality of plates consist of a first plate;
the plurality of plates consist of a second plate;
the plurality of plates consist of a third plate;
a foot;
the foot having a top and a bottom;
the foot having a first attachment plate;
the foot having a second attachment plate;
the foot having a main body;
the foot having a plurality of attachment features;
the foot having a plurality of securement features;
the foot having a plurality of spikes; the plurality of spikes having a plurality of adjustment features;
securing the at least one ladder leveling systems to a leg of a ladder;
placing the ladder on a surface;
stabilizing the ladder using the at least one ladder leveling systems; wherein stabilizing the ladder includes adjusting the at least one ladder leveling systems to the right height via the shaft clamp; wherein stabilizing the ladder includes adjusting the plurality of spikes to the desired engagement or disengagement positions; wherein stabilizing the ladder includes adjusting the plurality of securement features to the desired engagement or disengagement positions.

20. The method of claim 19, the at least one ladder stabilizing system further comprising:
wherein the slider clamp slides freely along the length of the shaft when the plurality of plates are engaged; wherein engagement of the plurality of plates if pressing of the plurality of plates away from the plate stop and causing the spring to compress;
wherein disengagement of the plurality of plates is releasing of the plurality of plates so that the spring forces the plurality of plates into contact with the plate stop;
wherein the cap provides a stop at the top of the shaft such that the main body can not slide further than the cap and become separated from the shaft;
wherein the cap provides for removal and assembly of the main body in operable connection with the shaft;
wherein the ball and socket joint provides for gyrational positioning; wherein gyrational positioning allows for the foot to change from perpendicular to the shaft to varying angles in various directions;
wherein the plurality of spikes can each be engaged and disengaged; wherein engagement is rotating the plurality of spikes such that the plurality of spikes extend further downward than the grip surface of the foot; wherein disengagement is rotating the plurality of spikes such that the plurality of spikes do not extend further downward than the grip surface of the foot;
wherein the plurality of securement features can be engaged and disengaged; wherein engagement of the plurality of securement features is screwing into a surface and securing system to the surface such that the system will stay in place; wherein disengagement is unscrewing the plurality of securement features from the surface such that the system can move about freely.
